(19) United States
(12) Patent Application Publication
(10) Pub. No.: US 2013/0103529 A1
(43) Pub. Date: Apr. 25, 2013

(54) FACILITATING FORMATION OF SERVICE CONTRACTS BETWEEN CONSUMERS AND SERVICE PROVIDERS

(71) Applicants: John P. Loveman, Hill AFB, UT (US); David J. Armitage, Colorado Springs, CO (US)

(72) Inventors: John P. Loveman, Hill AFB, UT (US); David J. Armitage, Colorado Springs, CO (US)

(73) Assignee: AGILE EQUITY LLC, Centennial, CO (US)

(21) Appl. No.: 13/280,882

(22) Filed: Oct. 25, 2011

(51) Int. Cl. G06Q 30/08

(52) U.S. Cl. 705/26.2

(57) ABSTRACT

Embodiments extend to methods, systems, and computer program products for facilitating the formation of location-sensitive service contracts between consumers and service providers. At the request of a consumer, an auction for a service is created. The auction specifies categorical selections that describe the type of work to be performed and a geographical location at which the service is to be performed. The auction is presented to service providers based on geographical proximity of the service providers to the location at which the service is to be performed and a comparison of the categorical selections with qualification data for the service providers. Bids are received from the service providers, and a winning service provider is determined. The consumer and the winning service provider form a service contract. Subsequently, it is determine that the consumer has paid the winning service provider for performance of the service contract.

### CROSS-REFERENCE TO RELATED APPLICATIONS

Not Applicable.

### BACKGROUND

### Background and Relevant Art

In service industries, service providers, who have skills, knowledge, and tools for completing jobs within their respective trades, market their skills and availability to consumers, who have projects or services that can be completed by the service providers. Generally, service providers market their skills and availability to consumers through traditional marketing channels, such as television, radio, billboards, classified advertisements, circulars, categorical phone book “Yellow Pages,” Internet marketing, word of mouth, etc. As such, service providers continually pay for a variety of marketing channels with the hope that their message will reach interested consumers and that their message will appeal to those consumers. When a consumer responds to a service provider's message, that consumer typically describes his or her perception of what will be required to complete a particular project, and the service provider provides a bid or estimate for the cost and time required to complete the project. Sometimes, forming a bid or estimate may involve the service provider visiting the site of the project to ascertain the work the service provider must accomplish.

When a consumer has a project or service to be completed, the consumer sifts through the various marketing channels to find a local service provider who can complete the project or service. As such, to find a service provider who the consumer estimates will be able to accomplish the project or service, a prudent consumer may engage in a timely process of calling various service providers to get bids, repeatedly describing the job to be accomplished, hosting several service providers for one-site bids, etc. While with extensive searching the consumer may be able to locate reviews and/or testimonials for service providers, often times the consumer must make his or her decision to use a particular service provider based on limited and/or biased information. For example, the consumer is often forced to decide on a particular service provider based on that service provider's own statement of quality and reliability. Alternatively, the service provider may provide the consumer with list of references that have been selected by the service provider. Such reference lists typically include only the consumers that were most satisfied with the service provider's services, and omit the consumers that were least satisfied with the service provider's services.

Given the difficulty of sifting through the various service providers, their bids, and their track records, many consumers simply choose the first service provider they contact, which is typically the service provider who has invested the most in marketing in the consumer's geographical area.

Accordingly, there are a number of difficulties to establishing relationships between consumers and service providers. For service providers, it can be difficult and expensive to target their marketing to consumers that need their services. For consumers, it can be difficult and time-consuming to locate a suitable service provider.

### BRIEF SUMMARY

The present invention extends to methods, systems, and computer program products for facilitating the formation of location-sensitive service contracts between consumers and service providers. In particular, embodiments of the present invention enable consumers to publicize the desirability for completion of a service at a particular geographical location, and to provide a mechanism for geographically-proximate service providers to bid for a contract to complete the service. As such, the present invention creates an efficient market between consumers and service providers by centralizing communications between consumers and service providers and by increasing competitive bidding between service providers.

Some embodiments facilitate the formation of service contracts between consumers and service providers. At the request of a consumer, a computer system creates an auction for a service. The auction specifies categorical selections that generally describe the type of work a service provider is to perform when completing the service and a geographical location at which the service is to be performed.

The computer system presents the auction to service providers. Presentation to each service provider is based on geographical proximity of the service provider to the location at which the service is to be performed and a comparison of the categorical selections with qualification data for the service provider. The computer system receives bids from the service providers, and determines that a particular service provider has won the auction. Subsequent to the particular service provider winning the auction, the consumer and the particular service provider form a service contract, and the computer system determines that the consumer has paid the particular service provider for completion of the service.

In response to the particular service provider winning the auction, the consumer and the particular service provider form a service contract. The computer system charges the consumer and/or the particular service provider based on the service contract being formed.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates formation of service contracts between consumers and service providers.

FIG. 2 illustrates a flow chart of an example method for facilitating formation of a service contract between a consumer and a service provider.

FIG. 3 illustrates a flow chart of an example method for performing an auction.

### DETAILED DESCRIPTION

The present invention extends to methods, systems, and computer program products for facilitating the formation of location-sensitive service contracts between consumers and service providers. In particular, embodiments of the present invention enable consumers to publicize the desirability for completion of a service at a particular geographical location, and provide a mechanism for geographically-proximate service providers to bid for a contract to complete the service. As such, the present invention creates an efficient market between consumers and service providers by centralizing communications between consumers and service providers and by increasing competitive bidding between service providers.

Some embodiments facilitate the formation of service contracts between consumers and service providers. At the request of a consumer, a computer system creates an auction for a service. The auction specifies categorical selections that generally describe the type of work a service provider is to perform when completing the service and a geographical location at which the service is to be performed.

The computer system presents the auction to service providers. Presentation to each service provider is based on geographical proximity of the service provider to the location at which the service is to be performed and a comparison of the categorical selections with qualification data for the service provider. The computer system receives bids from the service providers, and determines that a particular service provider has won the auction. Subsequent to the particular service provider winning the auction, the consumer and the particular service provider form a service contract, and the computer system determines that the consumer has paid the particular service provider for completion of the service.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In this description and in the attached claims, the term “service provider” should be broadly construed to include any individual or entity which provides services to other individuals or entities at a specific location. Service providers can provide services within a broad range of industries, such as construction, maintenance, cleaning, inspection, photography, real estate, technical support, repair, catering, education, child care, hospice, etc.

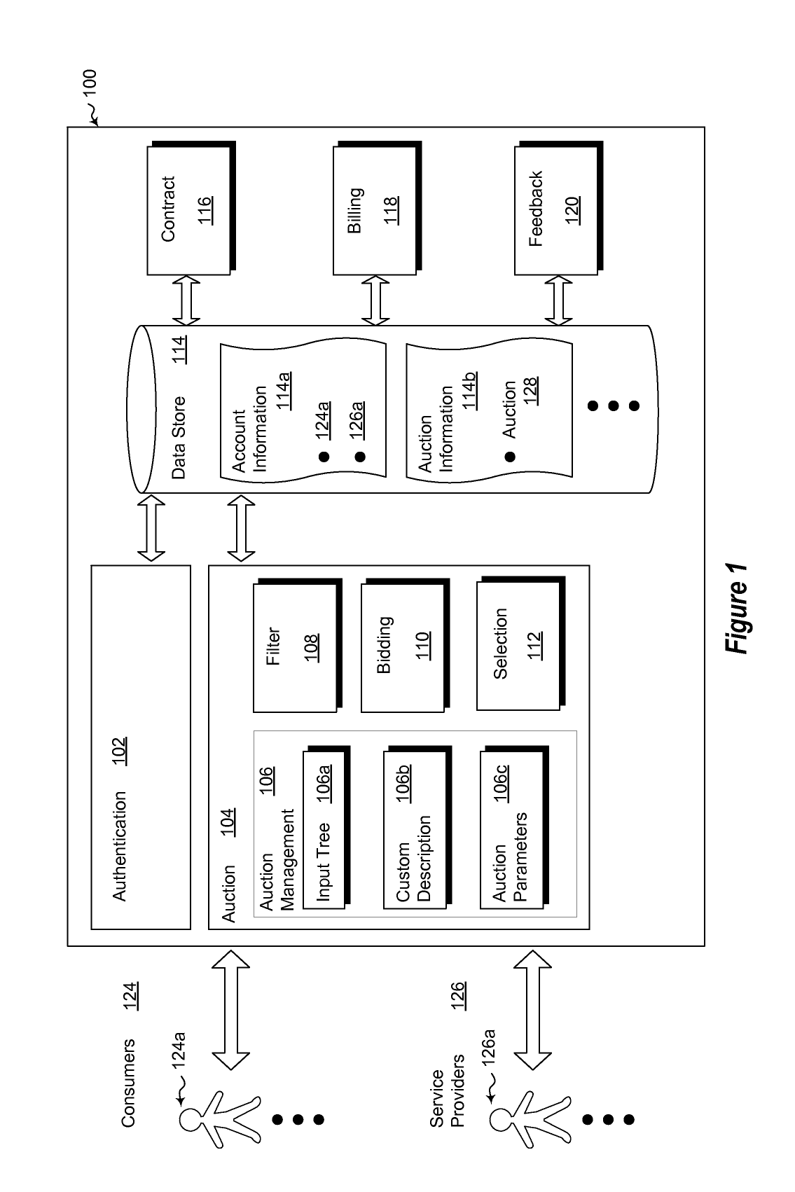

FIG. 1 illustrates an exemplary computer architecture 100 for facilitating formation of service contracts between consumers and service providers. Generally, computer architecture 100 enables consumers to create auctions describing services requested to be performed at a specified geographical location, and enables geographically-proximate service providers to bid against each other for formation of an agreement or contract to perform the auctioned services. As depicted in FIG. 1, computer architecture 100 includes authentication component 102, auction component 104, contract component 116, billing component 118, feedback component 120, and data store 114.

Each of the depicted components is connected to one another over (or is part of) a system bus or a network, such as, for example, a Local Area Network (“LAN”), a Wide Area Network (“WAN”), and even the Internet. Accordingly, each of the depicted components, as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network. As such, computer architecture 100 may comprise components executing at a single computer system, or components distributed across a plurality of computer systems.

Authentication component 102 is configured to receive and process registration and authentication requests. In particular, authentication component 102 is configured to manage registration and authentication of one or more consumers 124 and one or more service providers 126. When registering a particular consumer (e.g., consumer 124a), authentication component 102 can gather appropriate consumer information, such as address and billing information, and create an account for that consumer. When registering a particular service provider (e.g., service provider 126a), authentication component 102 can gather appropriate service provider information, such as business address, billing information, licensing information, qualifications, photos and/or textual descriptions of previous work, or any information that may be pertinent to consumers choosing that service provider, and create an account for the service provider. In some embodiments, a single user account may be used for both consumer functions and service provider functions.

As depicted, authentication component 102 is configured to store account information 114a in data store 114, such as account information for consumer 124a and service provider 126a. Authentication component is also configured to leverage stored account information 114a when authenticating users as consumers and service providers. Data store 114 can store any appropriate information related to the auctioning of services and the formation of contracts for those services. While depicted as a single component, data store 114 may comprise multiple data stores and may be distributed over a plurality of computer systems.

Auction component 104 is configured to manage one or more consumer-created auctions which solicit bids from geographically proximate service providers for jobs to be performed. As depicted, auction component 104 can include auction management module 106, filter module 108, bidding module 110, and selection module 112. While these modules are depicted as separate modules, one or more of the modules may be combined. Auction component 104 may include any additional number of modules, as appropriate.

Auction management module 106 is configured to guide consumers 124 through the posting of desired services as auctions, or through management of existing auctions by consumers 124 or service provider 126. For example, consumer 124a may use auction management module 106 to create an auction (e.g., auction 128 reflected in auction information 114b) for performance of a service, to view bids for the auction, to select a winning bidder, to modify or delete the auction, etc. In addition, service provider 126a may use auction management module 106 to view auctions on which service provider 126a has bid, to modify or remove those bids, etc. When guiding consumers 124 through the posting of a desired service, auction management module 106 can guide consumers 124 through input tree 106a, custom description 106b, and auction parameters 106c.

Input tree 106a is configured to provide consumers 124 with selectable categories of services, and enables consumers 124 to specify generic aspects of the desired service. Categorical selections in input tree 106a may range from singular to numerous. In one embodiment in which consumer 124a is creating an auction for a home painting service, for example, input tree 106a may request that consumer 124a select a postal code corresponding to the location where the service is to be performed, and then present consumer 124a with possible categories (e.g., Additions, Electrical, Flooring, Painting, etc). Upon selection of a category (e.g., Painting), input tree 106a may present consumer 124a with sub-categories (e.g., Interior Home, Specialty Finishes, Exterior Painting, etc.). Selection can continue through multiple levels of sub-categories, and comprise selection of multiple options within each category or sub-category. As such, input tree 106a can gather a detailed specification from consumers 124 for the type of work to be performed. Filter module 108 can later use this categorical specification to determine which auctions are applicable to particular service providers.

Custom description 106b is configured to enable consumers 124 to provide any additional information about the desired service that can help service providers 126 develop accurate bids. Custom description 106b can, for example, enable consumers 124 to provide photos, drawings, measurements, product specifics, and/or textual descriptions. Information provided by consumers 124 as part of custom description 106b can provide information such as shape, size, and scope of a project, while textual descriptions can provide details, desires, and expectations that may not be portrayed in images.

Auction parameters 106c is configured to enable consumers 124 to provide any additional options for their auctions. For example, additional options may include one or more of a reserve price (i.e., a minimum price that service providers 126 can bid for a particular service), a review reserve (i.e., a minimum review rating that service providers 126 must have to be allowed to bid), a number service providers that must bid before the auction can be resolved, service provider timeframe eligibility, the need for service providers 126 to do an on-site visit before making a bid, or a duration of the auction. In some embodiments, consumers 124 can establish some combination of threshold price, rating, and/or timeline that automatically end the bidding process and select a winning service provider (i.e., a “do it now” bid). In some embodiments, consumers 124 may be able to specify that the price of an auction is to be computed as a relative price, based on some measure of the services performed. For example, the price may be computed as a percentage of material costs, an hourly rate multiplied by the number of hours spent performing the service, or as a percentage of some other price (e.g., as a percentage of a sale resulting from the service, such as a commission resulting from a realtor selling property).

Auction management module 106 can be configured to create an auction from the information provided as part of input tree 106a, custom description 106b, and/or auction parameters 106c. Creating an auction may involve creating a web-page or application page. The auction can be stored within auction information 114b in data store 114, potentially along with other auctions, and be made available to service providers 126 for bidding. As depicted, for example, consumer 124a has created auction 128. In some embodiments, consumers 124 are not charged for posting the auction and service providers 126 are not charged for bidding on auctions. In some embodiments, the consumer posting the auction and/or the winning service provider may be charged after the auction has ended or after a service contract or agreement is ultimately formed.

Filter module 108 is configured to determine which auction(s) stored in auction information 114b is/are applicable to a given service provider based on information specified as part of the auction and information known about the service provider. In some embodiments, filter module 108 may determine auction(s) that is/are applicable to a given service provider automatically (e.g., when an auction is posted, or at a predefined interval) and send one or more notifications to the service provider letting the service provider know that the applicable auction(s) exist (e.g., in a text message, an e-mail message, mobile application notification, or the like). For example, after consumer 124a posts auction 128, filter module 108 may determine that auction 128 is applicable to service provider 126a, and initiate sending of a message to service provider 126a to let service provider 126a know that auction 128 exists. Notification preferences may be provided by service providers 126 as part of registration or a later modification of registration information, and stored as part of account information 114a.

In additional or alternative embodiments, filter module 108 may determine which auction(s) is/are applicable to a given service provider in response to a search request from the service provider. Filter module 108 can then initiate display of the applicable auction(s) as part of one or more sets of search results. For example, service provider 126a may authenticate with authentication component 102 and then use a search form provided by auction component 104 to search for current auctions. Filter module 108 may determine that auction 128 is applicable to service provider 126a, and present auction 128 to service provider 126a as part of search results.

Filter module 108 can compare categories chosen as part of input tree 106a by consumers 124 when creating auctions with information known about service providers 126 to determine which auction(s) is/are applicable to a given service provider. For example, filter module 108 may use categorical information known for each service provider 126. Categorical information about service providers 126 may be provided by service providers 126 at registration or as part of a search. In some embodiments, for example, service providers 126 may use an input tree similar to input tree 106a as part of registration and/or as part of a search. Categories selected by service providers 126 can be used to determine areas in which each services provider 126 is skilled for completing services, and/or areas in which each service provider 126 is currently seeking to complete services as part of a search.

In addition, filter module 108 can account for geographical proximity of each service provider 126 to the location at which each service is to be performed. Proximity calculations may be based on information provided by consumers 124 and service providers 126 as part of registration (e.g., address information), based on information selected by consumers 124 when creating auctions (e.g., information selected as part of input tree 106a), based on information provided by service providers 126 as part of a search, etc. In some embodiments, when a location is selected as part of a categorical selection, proximity is automatically taken into account when performing categorical comparisons.

Filter module 108 can account for many other parameters when determining which auctions to present to service providers 126. For example, filter module 108 can account for service provider ratings, service provider qualifications, desired bid price range, etc. In some embodiments, each service provider 126 can specify the distance the service provider is willing to travel to complete a service. Also, in some embodiments each service provider 126 may specify the distance dynamically so that the distance changes based on the anticipated price range of the bid. For example, a service provider may be willing to travel a larger distance for larger projects (e.g., to paint a 5,000 square foot house) than the service provider is willing to travel for smaller projects (e.g., to paint a 1,000 square foot house). In some embodiments, filter module 108 can present auctions to a given service provider based on proximity, bid price, timeframe, request for on-site visit, etc.

Bidding module 110 is configured to receive and process bids from service providers 126. In some embodiments, a bid can include combinations of a minimum bid price, a display bid price, a timeline to complete work, a qualitative description of the work the service provider will complete, guarantees, etc. The minimum bid price represents the lowest price the service provider would be willing to be paid to complete the service for which the service provider is bidding. The display bid price represents a price that is displayed to the consumer that created the auction and to other bidding service providers. In some embodiments, when another bid arrives with a bid price (e.g., minimum bid price or display bid price) equal to or less than the display bid price for an existing bid, but greater than or equal to the minimum bid price, bidding module 110 may automatically reduce the display price for the existing bid to match or beat the other bid. As such, service providers 126 may be freed from the need to constantly monitor the auctions on which they are bidding to ensure that they have not been underbid.

In some embodiments, bidding module 110 may automatically select a winning bidder. When creating auction 128, for example, consumer 124a may have specified a threshold conditions (e.g., bid price, rating, timeline) for a “do it now” bid. If service provider 126a enters a bid that meets these requirements, bidding module 110 may automatically select service provider 126a as the winning bidder. In some embodiments, bidding module 110 may wait until a certain number of bids have been received and/or until an expiration time of auction 128 has expired before selecting a winning bidder.

Additionally or alternatively, consumers 124 may be able to select the winning bidder for their auctions. For example, selection module 112 can present each consumer 124 with a listing of bids for the consumer's auction. As such, consumers 124 can weigh the various bids and come to a personal decision about which of the service providers 126 the consumer would like to complete the desired service. Consumers 124 can then provide selection module 112 with selection of the winning bidder for their auctions. In some embodiments, selection module 112 presents each consumer 124 with an overview of available bids, and enables each consumer 124 to select particular bids to receive additional details, such as information about each bidding service provider (e.g., reviews, licensing information, photos of previous work, a record of previously accomplished work, location, guarantees associated with work, qualitative descriptions contained in the bid).

Furthermore, bidding module 110 may enable consumers 124 to provide counteroffers. For example, selection module 112 may present each consumer 124 with a listing of bids that have been entered for the consumer's auction. Selection module 112 by also provide consumers 124 with the ability to select and review particular bids, and to draft counteroffers to one or more of the bids. Counter offers can include any appropriate parameters, such as price, timeline, maximum material cost, etc. Counteroffers may be enabled at many points in the bidding process. In some embodiments, consumers 124 may be able to make counteroffers to bids as the bids are received. In additional or alternative embodiments, counteroffers may be made at the end of an auction. For example, if an auction ends with no winning bidder (e.g., of no bid meets reserves and specifications set by the consumer when a duration of the auction ends), then the consumer may be provided the ability to select one or more of the bids and to enter counteroffers. A counteroffer, when accepted by a service provider, may end the bidding process.

In some embodiments, computer system 100 may include contract component 116, which is configured to initiate or verify formation of a service contract between consumers 126 and the winning bidders. The level of involvement that contract component 116 takes in forming the service contract can vary widely. In some embodiments, contract component 116 can fully form the service contract. In other embodiments, contract component 116 can refer the parties to a third party for formation of the service contract. Contract component 116 may also recommend one or more form contracts, or merely verify that a contract has been formed. Any combination of the foregoing is possible, and may be selectable by the parties. In some embodiments, computer system 100 only brings consumers 124 and winning service providers 126 together, and lets them work out any details relating to contracts or agreements. In such embodiments, contract component 116 may be omitted.

Billing component 118 is configured to facilitate payment from consumers to service providers related to formation and/or performance of service contracts, or to verify that payment has been made. Billing component 118 may leverage account information 114a stored in data store 114, which can include billing information. Billing component 118 may also leverage other billing information gathered at any time during the auction process. In some embodiments, billing component 118 receives and processes payment information directly, while in other embodiments billing component 118 makes use of third party payment services (e.g., PAYPAL, GOOGLE CHECKOUT, etc.). Billing component 118 may enable various payment forms, such as deposit, installment, payment in full, financed payment, etc. In some embodiments, billing component 118 can be configured to receive notice that payment has been made in-person between consumers 124 and service providers 126.

Billing component 118 may also be configured to receive payment for the service of providing auctions. In some embodiments, billing component 118 may collect payment only when an auction has been completed and a winning bidder has been determined. As such, consumers 124 may be permitted to register and post auctions free of charge, and service providers 126 may be permitted to register and bid on auctions free of charge. Then, if and when an auction has been completed and a winning bidder has been determined, billing component 118 may charge the consumer who posted the auction and/or the wining service provider for the auction and/or for formation of a service contract. Of course, other billing schemes are possible.

Feedback component 120 is configured to receive and process feedback from consumers 124 and service providers 126. Consumers 124 may be able to provide feedback concerning their experience with the entire auction process, including feedback regarding specific service providers. Feedback component 120 can aggregate user reviews of service providers 126, which can be used by consumers 124 during the auction/bidding process. As such, feedback component 120 may enable consumers 124 to establish a record of activities pertaining to service providers 126. In some embodiments, a consumer may be permitted to provide feedback for a service provider only after verification that the consumer has paid the service provider for completion of agreed-to work.

Consumer feedback can include overall ratings, quality of service, cost of services, satisfaction with service providers, etc. In some embodiments, consumer feedback may be used to form statistics about costs of services in local areas, to inform other consumers about quantitative and qualitative aspects of particular service providers, to provide images of the work of particular service providers, to form statistics about potential cost overruns or under-runs by specific providers, etc. As such, feedback component 120 can help produce an efficient marketplace in which consumers 124 have access to relevant information before hiring service providers 126.

In addition, feedback component 120 can enable service providers 126 to provide feedback about the auction and bidding process, and about specific consumers 124. For example, service providers 126 may be able to provide feedback about the reasonableness of a particular consumer's expectations, whether the consumer paid for services rendered, the ease of working with the customer, etc.

In some embodiments, one or more components within computer architecture 100 can be configured to verify contract performance by service providers 126. For example, one or more components may receive user input from consumers and/or service providers who have formed service contracts, specifying whether or not the service contracts have been performed according to the consumer's and service provider's expectations. When consumers do not accurately describe the work to be performed, or when service providers do not provide the services they described and promised, then the parties may be able to modify or cancel their service contract, either apart from computer architecture 100 or using components of computer architecture 100 (e.g., contract component 116 and/or billing component 118).

For example, the parties may use contract component 116 to change contract terms or to form a new contract. In addition, the parties may use billing component 118 to modify billing agreements, to issue any applicable refunds, to process further charges, etc. In some embodiments, contracts between any entity operating computer architecture 100 and consumers 124/service providers 126 absolve the entity operating computer architecture 100 from liability for misrepresentations by either consumers 124 or service providers 126. For example, authentication component 102 or auction component 104 can inform consumers 124 and service providers 126 of their potential liability and the lack of liability for the entity operating computer architecture 100 in a license agreement agreed to during registration, during creation of an auction, and/or during bidding on an auction.

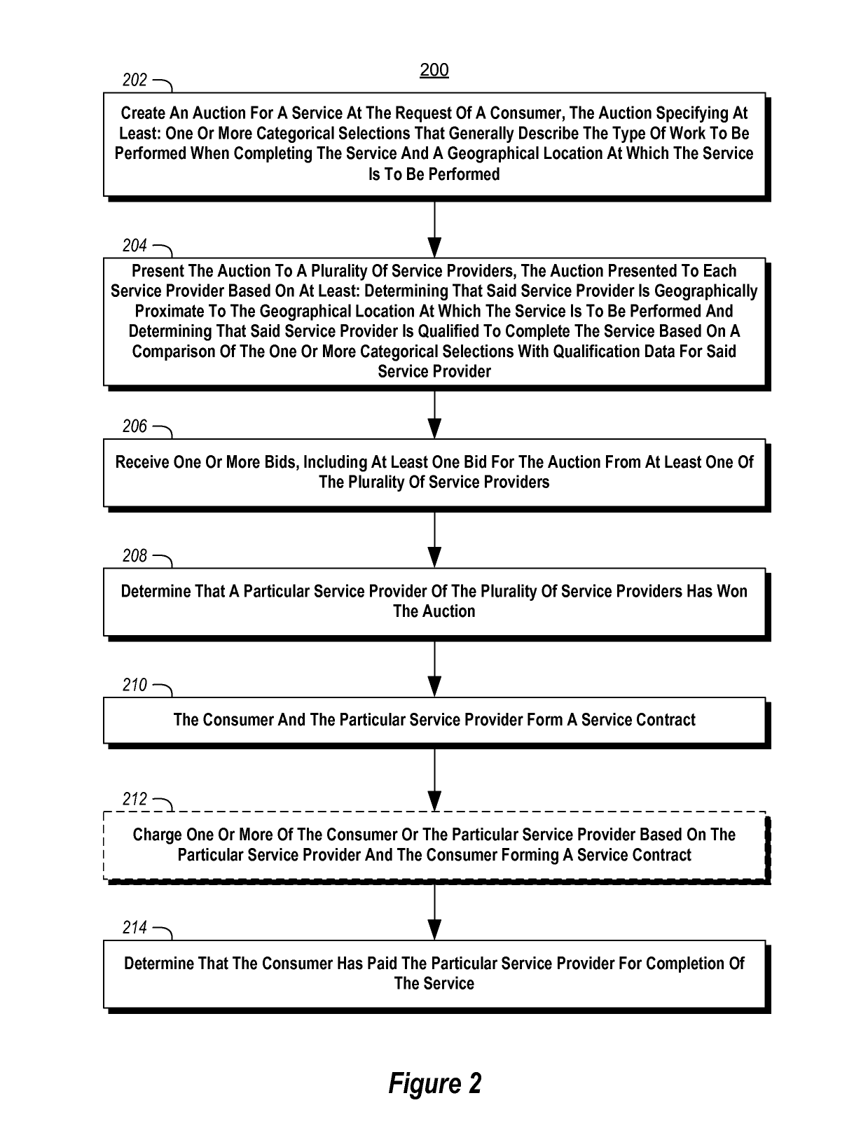

FIG. 2 illustrates a flow chart of an example method 200 for facilitating formation of a service contract between a consumer and a service provider. Method 200 will be described with respect to the components and data of computer architecture 100.

Method 200 includes an act of creating an auction for a service at the request of a consumer, the auction specifying at least: one or more categorical selections that generally describe the type of work to be performed when completing the service and a geographical location at which the service is to be performed (act 202). For example, after authenticating consumer 124a (which may include registering consumer 124a and/or authenticating consumer 124a using account information 114a), auction component 104 can receive a request from consumer 124a to create an auction. Auction component 104 can use auction management module 106 to guide consumer 124a through creation of auction 128, and store information relating to auction 128 in auction information 114b. In some embodiments, consumer 124a creates auction 128 free of charge.

Guiding consumer 124a through creation of auction 128 can include guiding consumer 124a through a categorical selection of work parameters that describe the type of work to be performed in input tree 106a, entering additional details (photos, textual description, measurements, etc.) in custom description 106b, and receiving additional parameters (e.g., a minimum bid price, a threshold bid price for a “do it now” auction, etc.) in auction parameters 106c. Auction management module 106 can also include a geographical location where the work is to be performed in auction 128. Location information can be received as part of input tree 106a, from account information 114a for consumer 124a, or from other input received from consumer 124a.

Method 200 also includes an act of presenting the auction to a plurality of service providers, the auction being presented to each service provider based on at least: determining that said service provider is geographically proximate to the geographical location at which the service is to be performed and determining that said service provider is qualified to complete the service based on a comparison of the one or more categorical selections with qualification data for said service provider (act 204). For example, filter module 108 can present auction 128 to service providers 126 based on those service providers being geographically proximate to the geographical location at which auction 128 is to be performed. Filter module 108 can also present auction 128 to service providers 126 based on service providers 126 being qualified for performing the work identified by the categorical selection of work parameters and/or service providers 126 specifically seeking work related to the categorical selection of certain work parameters. For example, filter module 108 can use location information and qualification information received from service providers 126. Filter module 108 can present auction 128 to service providers 126 as part of messages sent to service providers 126 or as part of search results presented to service providers 126.

Method 200 also includes an act of receiving one or more bids, including at least one bid for the auction from at least one of the plurality of service providers (act 206). For example, bidding module 110 can receive one or more bids from service providers 126, including at least one bid from service provider 126a. In some embodiments, service providers 126 can bid on auction 128 free of charge.

Method 200 also includes an act of determining that a particular service provider of the plurality of service providers has won the auction (act 208). For example, bidding module 110 may automatically determine that service provider 126a has won the auction based on service provider 126a providing the best bid within a defined time period, based on service provider 126a meeting the requirements of a “do it now” bid, etc. Alternatively, consumer 124a can use selection module 112 to view any bids, including the bid from service provider 126a, and manually select service provider 126a as the winning bidder. In some embodiments, when viewing bids, consumer 124a can obtain details about the bids, details and reviews about bidding service providers, and any other appropriate bidding information.

Method 200 also includes an act of the consumer and the particular service provider forming a service contract (act 210). For example, in response to the particular service provider winning the auction, consumer 124a and service provider 126a can form a service contract or agreement in which service provider 126a agrees to perform the requested service for consumer 124a. In some embodiments, contract component 116 fully or partially forms the service contract, or recommends form contracts or third parties who can assist in forming the service contract. In other embodiments, consumer 124a and service provider 126a form the contract themselves and notify contract component 116 that the contract has been formed. In yet other embodiments, consumer 124a and service provider 126a form a contract or agreement without providing any notification that the contract has been formed.

Method 200 may also include an act of charging one or more of the consumer or the particular service provider based on the particular service provider and the consumer forming a service contract (act 212). For example, in response to the particular service provider winning the auction, billing component 118 may charge consumer 124a for formation of the service contract and/or billing component 118 may charge service provider 126a for formation of the service contract. Billing can occur after formation of the service contract by contract component 116, after contract component 116 receives notice that a contract has been formed, and even before a service contract has officially been formed (e.g., in response to service provider 126a being selected as the winning bidder). In some embodiments, the billing component 118 may charge one or more of the consumer 124a and service provider 126a based on a percentage of the amount of the service contract, or a flat fee regardless of the amount of the contract.

Method 200 also includes an act of determining that the consumer has paid the particular service provider for completion of the service (act 214). For example, billing component 118 can facilitate payment by receiving payment from consumer 124a and forwarding the payment to service provider 126a, by facilitating an electronic payment from an account associated with consumer 124a to an account associate with service provider 126a, by making use of a third party (e.g., PAYPAL), or by using any other appropriate payment mechanism. Alternatively, billing component 118 can receive notice from one or more of consumer 124a or service provider 126a informing billing component 118 that payment has been made (e.g., an in-person payment).

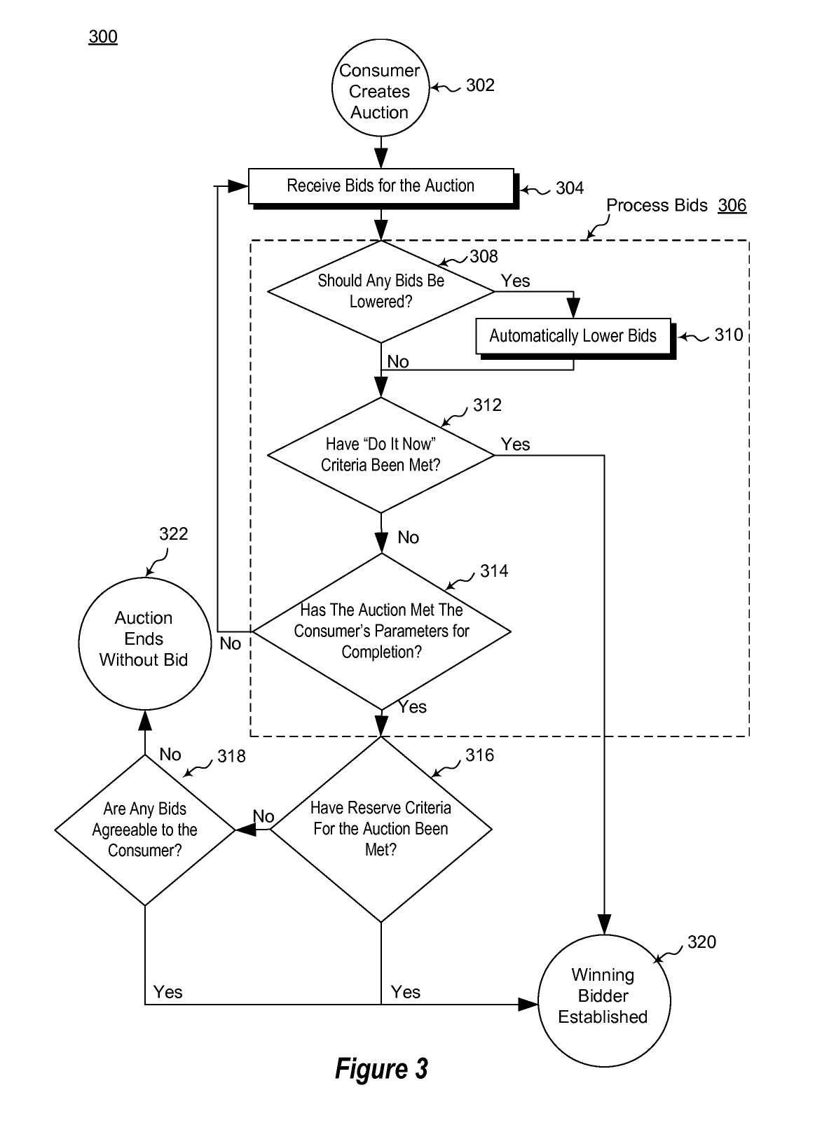

In addition, FIG. 3 illustrates a flow chart of an example method 300 for performing an auction. Method 300 will be described with respect to the components and data of computer architecture 100.

Method 300 includes an act of a consumer creating an auction (act 302). For example, consumer 124a can create auction 128 using auction management module 106, specifying categories of work to be performed (e.g., using input tree 106), additional details about the work (e.g., using custom description 106b), additional auction parameters (e.g., using auction parameters 106c). As part of creating auction 128, consumer 124a can specify threshold “do it now” criteria (e.g., price, qualifications, review ratings, etc.), parameters for completing the auction (e.g., number of bids, auction duration, etc.), reserve criteria (e.g., maximum bid prices, minimum qualifications, minimum ratings, etc.).

Method 300 also includes an act of receiving bids for the auction (act 304). For example, bidding module 110 can receive bids from service providers 126. Bids can include a minimum bid price, a display bid price, a qualitative description of the work to be performed, etc. The service provider may be able to specify that some bid parameters, such as display bid price, can be automatically adjusted to keep the bid competitive as other bids are received.

Method 300 also includes an act of processing received bids (act 306). For example, as bids are received bidding module 110 can perform various acts to determine whether the received bids affect any other bids, to determine whether any bids may comprise a winning bid, to determine whether the auction should continue, etc.

Act 306 includes an act of determining whether any bids should be lowered (act 308). For example, when a bid is received, bidding module 110 can determine whether any parameters of the bid (e.g., the display bid price) should be lowered in view of existing bids. In addition, bidding module 110 can determine whether any parameters of already existing bids should be lowered in view of the newly received bid. As depicted, if any bid(s) should be lowered (“Yes” at the decision block of act 308), then those bid(s) are lowered at act 310.

As such, act 306 includes act 310 of automatically lowering bids. For example, bidding module 110 may lower a first display bid price of a first bid to match or beat a second display bid price or second minimum bid price of a second bid, at least until the first display bid price of the first bid meets a first minimum bid price of the first bid.

Act 306 also includes an act of determining whether any “do it now” criteria have been met (act 312). For example, after it is determined that no bid(s) needed to be lowered (“No” at the decision block of act 308) or after bids have been lowered at act 310, bidding module 110 can determine whether any of the bids meet threshold “do it now” criteria set by consumer 124 for auction 128. “Do it now” criteria can comprise any combination of auction parameters, such as bid price, ratings of the bidding service providers, promised timeframes, etc. If a service provider's bid does meet the “do it now” criteria (“Yes” at the decision block of act 312), then bidding module 110 can establish that service provider as the winner at act 320. Otherwise, if no service provider's bid meets the “do it now” criteria (“No” at the decision block of act 312), then bidding module 110 can determine whether the auction has met the consumer's parameters for completion at act 314.

For example, at act 314 bidding module 110 can determine whether a specified duration of auction 128 has elapsed, whether there have been a sufficient number of bids, etc. If so, bidding module can proceed to act 316. Otherwise, bidding module can return to act 304 to obtain more bids.

At act 316 bidding module 110 determines whether any of the received bids meet the consumer's reserve criteria. For example, bidding module 110 can determine whether any service provider's bid meets parameters specified by consumer 124a, such as a bid price below a reserve maximum, a rating above a reserve minimum, etc. If so, (“Yes” at the decision block of act 316), then bidding module 110 can establish that service provider as the winner at act 320.

If no bid meets the reserve criteria (“No” at the decision block of act 316), or if there are multiple bids that meet the reserve, at act 318 selection module 112 can request user input selecting an agreeable bid. Alternatively, if there is no established reserve criteria and no established “do it now” criteria, at act 318 selection module 112 can request user input selecting an agreeable bid. If the consumer selects an agreeable bid (“Yes” at the decision block of act 318), then selection module 112 can establish the corresponding service provider as the winner at act 320. Otherwise, if the consumer indicates that no bid is agreeable (“No” at the decision block of act 318), then the auction ends with no winning bid at act 322.

Accordingly, embodiments of the present invention facilitate the formation of location-sensitive service contracts between consumers and service providers, enabling consumers to publicize the desirability for completion of a service at a particular geographical location, and providing a mechanism for geographically-proximate service providers to bid for a contract to complete the service. As such, the present invention creates an efficient market between consumers and service providers by centralizing communications between consumers and service providers and by increasing competitive bidding between service providers

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, a method for facilitating formation of a service contract between a consumer and a service provider, the method comprising:
an act of the computer system creating an auction for a service at the request of a consumer, the auction specifying at least: (i) one or more categorical selections that generally describe the type of work to be performed when completing the service and (ii) a geographical location at which the service is to be performed;
an act of the computer system presenting the auction to a plurality of service providers, the auction presented to each service provider based on at least: (i) determining that said service provider is geographically proximate to the geographical location at which the service is to be performed and (ii) determining that said service provider is qualified to complete the service based on a comparison of the one or more categorical selections with qualification data for said service provider;
an act of the computer system receiving one or more bids, including at least one bid for the auction from at least one of the plurality of service providers;
an act of the computer system determining that a particular service provider of the plurality of service providers has won the auction;
subsequent to the particular service provider winning the auction:
the consumer and the particular service provider forming a service contract; and
the computer system determining that the consumer has paid the particular service provider for completion of the service.

2. The method as recited in claim 1, wherein the act of the computer system receiving one or more bids, including at least one bid for the auction from at least one of the plurality of service providers, comprises:
an act of receiving a first bid from the particular service provider, the first bid including a first minimum bid price for completing the requested service and a first display bid price that is greater than the first minimum bid price;
an act of receiving a second bid from a different service provider of the plurality of service providers, the second bid including a second minimum bid price that is greater than the first minimum bid price and less than the first display bid price; and
an act of reducing the first display bid price for the first bid to a second display bid price that is equal to or less than the second minimum bid price in response to receiving the second bid.

3. The method as recited in claim 1, wherein the act of the computer system presenting the auction to a plurality of service providers comprises an act of the computer system sending a notification of the existence of the auction to at least one of the a plurality of service providers.

4. The method as recited in claim 1, wherein the act of the computer system presenting the auction to a plurality of service providers comprises an act of the computer system presenting the auction as part of one or more search results.

5. The method as recited in claim 1, wherein, for at least one service provider, determining that said service provider is geographically proximate to the geographical location at which the service is to be performed comprises adjusting a geographical size of the proximity based on an anticipated cost for completing the service.

6. The method as recited in claim 1, wherein the auction also specifies a threshold bid price, and wherein the act of the computer system determining that a particular service provider of the plurality of service providers has won the auction comprises an act of the computer system automatically ending the auction based at least in part on the particular service provider bidding at, or below, the threshold bid price.

7. The method as recited in claim 1, further comprising:
an act of the computer system presenting the consumer with details of each of the one or more bids; and
an act of the computer system receiving user input from the consumer selecting a bid from the particular service provider as a winning bid.

8. The method as recited in claim 7, wherein the act of the computer system determining that a particular service provider of the plurality of service providers has won the auction comprises an act of the computer system receiving the user input from the consumer selecting the winning bid from the particular service provider.

9. The method as recited in claim 7, wherein the act of the computer system presenting the consumer with details of each of the one or more bids comprises an act of the computer system providing the consumer with access to information about at least one of the plurality of service providers, including one or more of: reviews, licensing information, a record of previously completed work, location information, or guarantee information.

10. The method as recited in claim 1, wherein:
the auction also specifies custom information relevant to completion of the service including one or more of: one or more photographs, one or more drawings, one or more measurements, or one or more textual descriptions; and
the act of the computer system presenting the auction to a plurality of service providers comprises an act of the computer system presenting both the one or more categorical selections and the custom information to the plurality of service providers.

11. The method as recited in claim 1, wherein at least one of the one or more bids includes one or more of: a timeline to complete work or a qualitative description of work that a bidding service provider will complete.

12. The method as recited in claim 1, further comprising:
an act of the computer system charging one or more of the consumer or the particular service provider based on the particular service provider winning the auction.

13. The method as recited in claim 1, wherein the act of the computer system determining that the consumer has paid the particular service provider for completion of the service comprises an act of the computer system receiving notification from one or more of the consumer or the particular service provider, the notification indicating that the consumer has paid the particular service provider.

14. The method as recited in claim 1, wherein the act of the computer system determining that the consumer has paid the particular service provider for completion of the service comprises an act of the computer system facilitating the consumer making payment to the particular service provider.

15. The method as recited in claim 1, further comprising:
an act of the computer system receiving feedback concerning the consumer from the particular service provider; and
an act of the computer system presenting the feedback concerning the consumer to a least one other service provider.

16. The method as recited in claim 1, further comprising:
subsequent to determining that the consumer has paid the particular service provider for completion of the service, an act of the computer system enabling the consumer to enter feedback concerning the particular service provider;
an act of the computer system receiving feedback concerning the particular service provider from the consumer; and
an act of the computer system presenting the feedback concerning the particular service provider to a least one other consumer.

17. The method as recited in claim 1, wherein:
the auction also specifies additional service provider requirements, including one or more of a minimum bid price, a minimum service provider review rating, a service provider timeframe eligibility, a requirement for an on-site visit prior to submission of a bid, or a duration of the auction; and
the auction is presented to each service provider based on the additional service provider requirements.

18. The method as recited in claim 1, further comprising:
an act of registering the consumer based on a consumer registration request, the consumer registration request including a geographical location of the consumer and billing information for the consumer; and
an act of registering the particular service provider based on a service provider registration request, the service provider registration request including a geographical location of the service provider, billing information for the particular service provider, and qualification data for the particular service provider.

19. A computer program product comprising one or more computer storage devices having stored thereon computer-executable instructions that, when executed, cause one or more processors in a computer system to perform a method for facilitating formation of a service contract between a consumer and a service provider, and wherein the method is comprised of the following acts:
creating an auction for a service at the request of a consumer, the auction specifying at least: (i) one or more categorical selections that generally describe the type of work to be performed when completing the service and (ii) a geographical location at which the service is to be performed;
presenting the auction to a plurality of service providers, the auction presented to each service provider based on at least: (i) determining that said service provider is geographically proximate to the geographical location at which the service is to be performed and (ii) determining that said service provider is qualified to complete the service based on a comparison of the one or more categorical selections with qualification data for said service provider;
receiving one or more of bids, including at least one bid for the auction from at least one of the plurality of service providers;
determining that a particular service provider of the plurality of service providers has won the auction; and
charging one or more of the consumer or the particular service provider based on the particular service provider and the consumer forming a service contract.

20. A computer system, comprising:
one or more processors; and
one or more computer storage devices storing computer-executable instructions that, when executed by the one or more processors, cause the computer system to perform a method for facilitating formation of a service contract between a consumer and a service provider, including the following:
create an auction for a service at the request of a consumer, the auction specifying at least: (i) one or more categorical selections that generally describe the type of work to be performed when completing the service and (ii) a geographical location at which the service is to be performed;
present the auction to a plurality of service providers, the auction presented to each service provider based on at least: (i) determining that said service provider is geographically proximate to the geographical location at which the service is to be performed and (ii) determining that said service provider is qualified to complete the service based on a comparison of the one or more categorical selections with qualification data for said service provider;
receive one or more bids for the auction from at least one of the plurality of service providers;
determine that a particular service provider of the plurality of service providers has won the auction;
confirm that the particular service provider and the consumer have formed a service contract; and
facilitate payment of the particular service provider by the consumer for performance of the service by the particular service provider.
